(19) United States
(12) Patent Application Publication
(10) Pub. No.: US 2016/0027066 A1
(43) Pub. Date: Jan. 28, 2016

(54) MECHANISM FOR FACILITATING DYNAMIC USER-BASED CUSTOMIZATION OF ADVERTISEMENT CONTENT AT COMPUTING DEVICES

(71) Applicant: INTEL CORPORATION, Santa Clara, CA (US)

(72) Inventors: THOMAS SACHSON, MENLO PARK, CA (US); MICHAEL DALE WITTEMAN, PORTLAND, OR (US); JOSE ELMER SAAVEDRA LORENZO, SANTA CLARA, CA (US); MARY D. SMILEY, SAN FRANCISCO, CA (US); YIMIN ZHANG, BEIJING, 11 (CN); WENLONG LI, BEIJING, 8 (CN); SHIBANI KAPOOR SHAH, SAN JOSE, CA (US); PHILIP JOSEPH CORRIVEAU, CARLTON, OR (US); KANCHAN JAHAGIRDAR, FOLSOM, CA (US); YINNI GUO, SAN JOSE, CA (US); CRISTINA CHOPRA NEMETH, BEAVERTON, OR (US); NEWFEL HARRAT, BURLINGAME, CA (US)

(73) Assignee: INTEL CORPORATION, SANTA CLARA, CA (US)

(21) Appl. No.: 14/775,597

(22) PCT Filed: Dec. 27, 2013
(86) PCT No.: PCT/US13/77921

§ 371 Date: Sep. 11, 2015

Related U.S. Application Data
(60) Provisional application No. 61/836,983, filed on Jun. 19, 2013.

(51) Int. Cl. G06Q 30/02

(52) U.S. Cl. CPC G06Q 30/0275

(57) ABSTRACT

A mechanism is described for facilitating dynamic user-based customization of advertisement content at computing devices according to one embodiment. A method of embodiments, as described herein, includes receiving an advertiser content to be published on an avatar list, where the advertiser content is associated with an advertising entity, and verifying the advertiser content for publication, where verifying further includes assigning a ranking to the advertiser content. The ranking represents a position on the avatar list. The method may further include transmitting a publication notification identifying the ranking assigned to the advertiser content, and facilitating an auction for bidding to allow the advertising entity to obtain a higher ranking for the advertiser content than the assigned ranking, if the assigned ranking is rejected by the advertising entity.

### CROSS-REFERENCE TO RELATED APPLICATIONS

This patent application claims priority to and the benefit of U.S. Provisional Patent Application No. 61/836,983, filed Jun. 19, 2013, entitled “User-Generated Content Advertising System” by Thomas Sachson, et al., Attorney Docket No.: 42P105798, and the entire contents of which are incorporated herein by reference.

### FIELD

Embodiments described herein generally relate to computer programming More particularly, embodiments relate to a mechanism for facilitating dynamic user-based customization of advertisement content at computing devices.

### BACKGROUND

Advertisement-driven revenue has become increasingly common and necessary, particularly as software and services move to applications and web services that often require continuous support and maintenance. However, these revenue-generating advertisements (e.g., banner advertisements, popups, etc.) are not only annoying to users, but also leave most users insecure about their privacy when user data is often accessed for such purposes.

### BRIEF DESCRIPTION OF THE DRAWINGS

Embodiments are illustrated by way of example, and not by way of limitation, in the figures of the accompanying drawings in which like reference numerals refer to similar elements.

FIG. 1 illustrates an advertisement customization mechanism employed at a computing device according to one embodiment.

FIG. 2 illustrates an advertisement customization mechanism according to one embodiment.

FIG. 3A illustrates a method for facilitating publication of brand avatars for user-based customization and brand-morphism according to one embodiment.

FIG. 3B illustrates a method for facilitating brand-morphism of brand avatars and distribution of brand-morphed avatars according to one embodiment.

FIG. 3C illustrates a method for facilitating generation and communication of brand avatars for publication according to one embodiment.

FIG. 3D illustrates distribution of a brand-morphed avatar according to one embodiment

FIG. 4 illustrates computer system suitable for implementing embodiments of the present disclosure according to one embodiment.

### DETAILED DESCRIPTION

In the following description, numerous specific details are set forth. However, embodiments, as described herein, may be practiced without these specific details. In other instances, well-known circuits, structures and techniques have not been shown in details in order not to obscure the understanding of this description.

Embodiments provide for a dynamic and efficient facilitation of user-based customization of advertisement content at a computing device (e.g., mobile computing device, such as a smartphone, a tablet computer, etc.) to be distributed to other computing devices over one or more networks (e.g., Internet, cloud network, proximity network, etc.). In some embodiments, a user may customize advertisement content through brand-morphism or content-morphism (also referred to as “content morphism” or “brandmorphism”), such as morphing or combining an advertiser's content or brand avatar (e.g., characters, mascots, symbols, mascots, such as the Coca-Cola® or Coke® bottle or polar bear, the Disney® Mickey™, the Geico® gecko, various movie characters, etc.) with the user's content (e.g., speech/message using voice, videos, pictures, animation, etc.) to form a customized advertisement content (such as Geico®'s gecko saying “Happy New Year!” in the user's voice) which may then be distributed by the user to other users (e.g., friends, family, etc.), over one or more networks, using one or more computing devices.

It is to be noted that although brand-morphism of advertiser avatars with user contents is discussed throughout this document for brevity, clarity, and ease of understanding, embodiments are not limited to only avatars or any particular type of advertiser bands or user contents. For example, in one embodiment, any number and type of advertiser content (e.g., avatars, movies, music, text, webpages, blogs, audio recordings, etc., or any combination thereof (collectively referred to as “brand avatar” or simply “avatar”)) may be content-morphed or brand-morphed with any number and type of user content (e.g., voice, static images, videos, animation, features movements, etc., or any combination thereof).

Throughout this document, terms like “logic”, “component”, “module”, “framework”, “engine”, “store”, or the like, may be referenced interchangeably and include, by way of example, software, hardware, and/or any combination of software and hardware, such as firmware. Further, any use of a particular brand, word, term, phrase, name, acronym, or the like, such as “content-morphism”, “brand-morphism”, “brand”, “morphism”, “avatar”, “pocket avatar”, “mobile avatar”, “advertiser”, “advertisement”, etc., should not be read to limit embodiments to software or devices that carry that label in products or in literature external to this document.

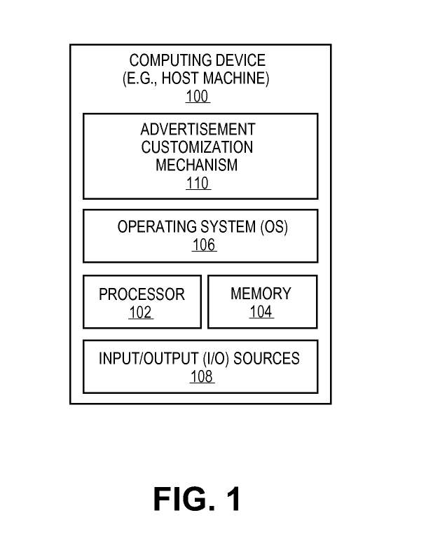

FIG. 1 illustrates an advertisement customization mechanism 110 employed at a computing device 100 according to one embodiment. Computing device 100 serves as a host machine for employing advertisement customization mechanism (“customization mechanism”) 110. Computing device 100 may include large computing systems, such as server computers, desktop computers, etc., and may further include set-top boxes (e.g., Internet-based cable television set-top boxes, etc.), global positioning system (GPS)-based devices, etc. Computing device 100 may include mobile computing devices, such as cellular phones including smartphones (e.g., iPhone® by Apple®, BlackBerry® by Research in Motion®, etc.), personal digital assistants (PDAs), tablet computers (e.g., iPad® by Apple®, Galaxy 3® by Samsung®, etc.), laptop computers (e.g., notebook, netbook, Ultrabook™, etc.), e-readers (e.g., Kindle® by Amazon®, Nook® by Barnes and Nobles®, etc.), etc.

Computing device 100 includes an operating system (OS) 106 serving as an interface between any hardware or physical resources of the computer device 100 and a user. Computing device 100 further includes one or more processors 102, memory devices 104, network devices, drivers, or the like, as well as input/output (I/O) sources 108, such as touchscreens, touch panels, touch pads, virtual or regular keyboards, virtual or regular mice, etc. It is to be noted that terms like “node”, “computing node”, “server”, “server device”, “cloud computer”, “cloud server”, “cloud server computer”, “machine”, “host machine”, “device”, “computing device”, “computer”, “computing system”, and the like, may be used interchangeably throughout this document. It is to be further noted that terms like “application”, “software application”, “program”, “software program”, “package”, and “software package” may be used interchangeably throughout this document. Similarly, terms like “job”, “input”, “request” and “message” may be used interchangeably throughout this document.

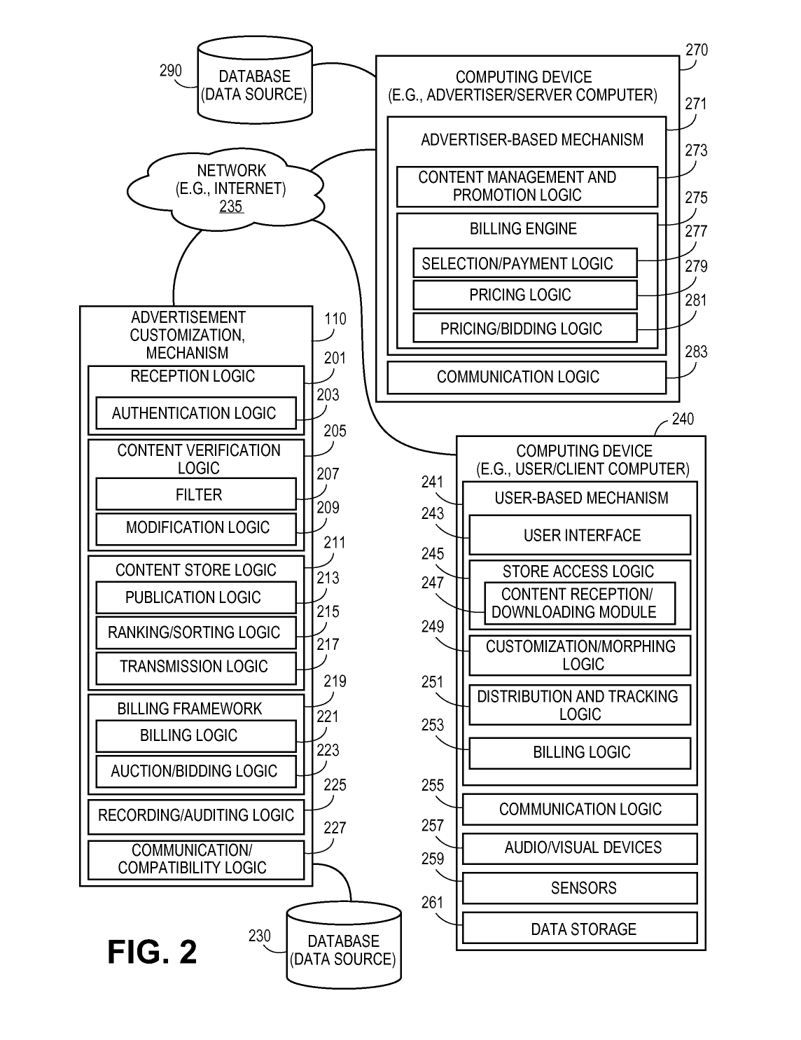

FIG. 2 illustrates an advertisement customization mechanism 110 according to one embodiment. In one embodiment, customization mechanism 110 may include a number of components, such as: reception logic 201 having authentication module 203; content verification logic 205 having filter 207 and modification logic 209; content store logic 211 having publication logic 213, ranking/sorting logic 215, and transmission logic 217; billing framework 219 having billing logic 221 and auction/bidding logic 223; recording/auditing logic 225; and communication/compatibility logic 227.

Customization mechanism 110 may be hosted at a host machine, such as computing device 100 of FIG. 1, and further be in communication with one or more databases or data sources, such as database 230, for maintaining any number and type of data, resources, policies, raw files, distributed file system, cloud storage, etc., and one or more computing devices, such as computing device 240 (e.g., user-accessible client computing device, such as a desktop computer or a portable or mobile computer including a smartphone, a tablet computer, a laptop computer, etc.) and computing device 270 (e.g., third-party accessible server computer, etc.) over one or more networks, such as network 235 (such as a cloud network, the Internet, etc.).

In one embodiment, computing device 240 may include a client computing device hosting user-based mechanism 241 which includes any number and type of components, such as: user interface 243 (e.g., web user interface (WUI), graphical user interface (GUI), touchscreen, etc.); store access logic 245 having content reception/downloading module 247; customization/morphing logic 249; distribution and tracking logic 251; and billing logic 253. Computing device 240 may further include audio/visual devices 257 (e.g., cameras, microphones, speakers, etc.), context-aware sensors 259 (e.g., temperature sensors, facial expression and feature measurement sensors working with one or more cameras of audio/visual devices 257, environment sensors (such as to sense background colors, lights, etc.), biometric sensors (such as to detect fingerprints, etc.), user calendar reader, etc.), communication logic 255, and one or more local storage mediums/devices and/or memory, such as local storage 261, for storing and caching data. In some embodiments, user-based mechanism 241 may include a software application that can be deployed on computing device 240.

In some embodiments, computing device 270 may include a third-party server computing device hosting advertiser-based mechanism 271 having one or more components, such as: content management and promotion logic 273 and billing engine 275 having selection/payment logic 277, pricing logic 279, and pricing/bidding logic 281. Computing device 270 may include communication logic 283 and be further in communication with one or more databases or data sources, such as database 290, and other computing devices, such as the host machine employing customization mechanism 110, over one or more networks, such as network 235.

In one embodiment, an advertiser (also referred to as “third-party”, “advertising sponsor” or simply “sponsor”), associated with computing device 270, may choose to participate in advertising campaign to promote its brand (to ultimately promote its products and/or services, etc.), where the promotion campaign may be launched and managed via customization mechanism 110. The advertiser may initiate it participation in the campaign by choosing to opt-in with customization mechanism 110 over network 235. As will be further described later in this document, the advertiser may choose from any number and type of promotion campaigns, billing services, etc. An advertiser may include, but is not limited to, any type of an entity or organization, such as a business of any size and type, a company, a partnership, a corporation, a non-profit entity (e.g., philanthropic foundation, etc.), an institution (e.g., educational institution, such as a university, etc.), an agency (e.g., government agency, etc.), etc. Similarly, an organization (referred to as “provider”), such as Intel® Corporation, may serve as an owner, provider, and/or sponsor of customization mechanism 110.

A user associated computing device 240 may include an end-user of any demographics. For example, as will be further described, it is contemplated that the user of computing device 240 may be a customer (or client) of the advertiser associated with computing device 270, where the advertiser may be a customer of the provider of customization mechanism 110 and accordingly, opt-in to participate in a brand promotion campaign facilitated by customization mechanism 110 to promote its brand and therefore, its products, services, etc., to not only the user of computing device 240, but also to other potential or existing customers/users associated with or known to the user. It is contemplated that an advertiser is not limited to any particular type or number of entities, but for brevity and clarity, one or more known companies, such as Coke®, Disney®, Geico®, etc., are referenced and used as examples throughout this document.

For example and in one embodiment, once the advertiser (e.g., Coke®) has registered for promoting its brand (e.g., the Coke® bottle) through a brand campaign, content management and promotion logic 273 of advertiser-based mechanism 271 may be used to prepare or put together the relevant brand content or avatar to be provided to customization mechanism 110 for promotion. For example, the avatar may be prepared according to the criteria set by customization mechanism 110, where the criteria may include, but not limited, to size of avatar, number of pixels, font size, acceptable colors, etc. Similarly, advertiser-based mechanism 271 may also have been made aware of other criteria or offers, such as various billing offers, so that appropriate offers and/or methods may be selected by selection/payment logic 277 of billing engine 275 of advertisement-based mechanism 271.

As aforementioned, it is to be noted that although brand-morphism of advertiser avatars with user contents is discussed throughout this document for brevity, clarity, and ease of understanding, embodiments are not limited to only avatars or any particular type of advertiser bands or user contents. For example, in one embodiment, any number and type of advertiser content (e.g., avatars, movies, music, text, webpages, blogs, audio recordings, etc., or any combination thereof (collectively referred to as “brand avatar” or simply “avatar”)) may be content-morphed or brand-morphed with any number and type of user content (e.g., voice, static images, videos, animation, features movements, etc., or any combination thereof).

In one embodiment, billing framework 219 of customization mechanism 110 may offer the advertiser various billing options, such as a flat or an incrementally increasing or decreasing price through billing logic 221 and/or a bidding offer through auction/billing logic 223. For example, billing logic 221 may provide a menu of prices for the advertiser to sort through and choose from to have what might be considered the best option for the advertiser. It is contemplated that any number and type of billing options may be provided, but a few examples are discussed here. For example, the advertiser (e.g., Coke®) may agree to pay $0.10 each time its avatar (e.g., Coke® bottle) is downloaded by a user, such as the user associated with computing device 240, up to a million downloaded avatars. This option may be extended to include not only the downloaded avatars, but also forwarded avatars, such as the advertiser may agree to play the provider $0.10/avatar for each avatar that is downloaded at a computing device, such as computing device 240, as well as for each morphed avatar (e.g., brand-morphed avatar, as will be further discussed later in this document) to other users associated with other computing devices.

Furthermore, depending on the type or extent of brand promotion the advertiser may desire, a limit may be placed on the promotion. For example, the advertiser may agree to play $0.10/avatar for up to a million avatars that are downloaded and/or forwarded, or agree to a combination, such as $0.15/avatar for each downloaded avatar for up to a million avatars and $0.10/avatar for each forwarded morphed avatar for up a million avatars. It is contemplated that the promotion limit in not merely confined to a number of avatars that are downloaded and/or forwarded, but that it may also include other forms of limits, such as, but not limited to, time, dollar amount, and any combination thereof. For example, the advertiser may request that the brand promotion be terminated once a total amount owed by the advertiser to the provider reaches a predetermined limit, such as $1,000,000, or that

It is contemplated that various price arrangements and/or promotion limits may include any number and type of combinations of prices, products, time periods, seasons, geographic locations, demographics, etc. For example, the advertiser may wish to pay $0.15/avatar for all avatars that are downloaded and/or forwarded (1) in the evening (e.g., 6-10 PM), (2) by individuals between the ages of 13 and 21, and/or (3) in any of the South American countries, but pay $0.10/avatars at all other times and demographics. This may be for one of the brand avatars, such as Coke® bottle. The same advertiser, such as Coke®, may wish to pay a flat $0.10/avatar for its other avatar, such as Coke® polar bear, regardless of whether it is downloaded or forwarded and when that downloading and/or forwarding is performed. Similarly, the advertiser may choose to place different termination limits on the two aforementioned campaigns, such as the advertiser may request that the first (Coke® bottle) campaign ends in six months, but that its second (Coke® polar bear) campaign should end when the total advertising campaign amount owed by the advertiser to the provider reaches $100,000 or, in other words, the total number of downloaded and/or forwarded avatars reaches 1,000,000 avatars.

In some embodiments, upon termination of an advertisement campaign, the provider may choose continue the brand campaign (particularly, if the brand is popular) and charge the users directly for the brand avatar. For example, upon reaching 1,000,000 avatars, Coke®'s polar bear campaign ends, but the provider may continue to publish polar bear avatars through its content store logic 211 for interested users who may wish to pay for the avatars themselves. The provider may choose to charge the user the same price (e.g., $0.10/avatar) as was being charged to the advertiser or prefer a different rate (e.g., $0.05/avatar). Since these brand avatars are designed to promote the advertisers' product and/or services, most advertisers may not object to the provider continuing with publishing their brand avatars by directly charging the users, but naturally, the publisher may not do so if an advertiser objects to it.

Referring back to the advertiser's brand avatar created or proposed by content management and promotion logic 273, the avatar may then be communicated, via communication logic 283, to customization mechanism 110 where it is received at reception logic 201, via communication/compatibility logic 227. In one embodiment, one or more billing methods may also be selected from a billing menu by selection/payment logic 277 and enforced through pricing logic 279 to the cost may be tracked and upon receiving an invoice from the provider, via billing framework 219, an appropriate payment in response to the invoice may be made by the advertiser, via selection/payment logic 277, to the provider. In another embodiment, billing methods may be chosen or proposed before or after the brand avatar is communicated to customization mechanism 110. Further, it is contemplated that any number and type of billing, accounting, and/or financial systems may be employed, supported, and used (by billing framework 219, billing engine 275, and/or billing logic 253) for billing, invoicing, accounts payables, accounts receivables, etc.

Once the brand avatar is received at reception logic 201, the brand avatar, computing device 270, and/or the advertiser may be authenticated using any number and type of authentication and security systems, such as via unique identification, Internet Protocol (IP) address, username, password, etc. Once authentication process is completed, the brand avatar is provided to content verification logic 208 so the brand and any relevant content may be verified. The verification process, as facilitated by verification logic 208, may include verifying of the content associated with the avatar as well as its technical features. For example, the avatar may be rejected due to its unacceptable size, pixel density, colors, illicit or offensive content, etc. If the avatar is rejected for one or more reasons, it may be deleted or sent back to advertiser-based mechanism 271 and the advertiser may be notified of the rejection and requested to resubmit an acceptable avatar.

However, in some embodiments, if the problems are minor in nature, whether they may be content-related or technical, such problems may be corrected or modified via modification logic 209. For example, typos, minor and unintentional grammatical errors, minor color or pixel changes, small size modifications, etc., may be corrected using modification logic 209. Similarly, in some embodiments, for deletion of certain contents and/or features, the avatar and its relevant content may be put through filter 207. For example, an inappropriate or offensive word me be deleted, an extra or unintentional character or color, etc., may be filtered out of the avatar. In some embodiments, the filtered avatar may be communicated back to content management and promotion logic 273 of advertiser-based mechanism 271 for final approval. Once the approval is received at customization mechanism 110 from advertiser-based mechanism 271, the corrected or filtered avatar may then be forwarded on to content store logic 211 for further processing.

In one embodiment, publication logic 213 of content store logic 211 may be used to publish the avatar received from content verification logic 205 at an avatar store. For example, the avatar may be stored or maintained at database 230 and published using via an avatar store which may be a software application accessible to end-users via a computing device, such as computing device 240. For example, computing device 240 may employ user-based mechanism 241 which may be a software application capable of being downloaded at computing device 240. For example, the user associated with computing device 240 may view the avatar store website or application via user interface 243 and access one or more brand avatars published in the store via store access logic 245. In one embodiment, store access logic 245 may provide access to any number and type of brand avatar display via the avatar store and further, the user may select one or more avatars from the avatar store via store access logic 245. Upon selecting an avatar (e.g., Coke® bottle, etc.), the user may request and receive, via content reception/downloading module 247, the selected avatar at computing device 240, where the transmission of the selected avatar is facilitated by transmission logic 217 in cooperation with communication/compatibility logic 227 and communication logic 255.

On the provider-side, any number and type of avatars may be published at the avatar store, via publication logic 213, and these avatars may be rated and/or sorted, via ranking/sorting logic 215, for any number of reasons ranging from providing ease to the user in selecting one or more avatars to actively promoting a particular avatar for the user to select. For example, in one embodiment, the avatars may be sorted in any number of known ways, such as in alphabetical order, chronological order, etc., so provide the user an easier way to select one or more avatars from any number and type of avatars. In another embodiment, each avatar may be ranked and the display order of these avatars may be based their ranks, which may be in an ascending or descending order. In one embodiment, the advertisers may be provided the opportunity purchase one or more ranks for their avatars as facilitated by auction/bidding logic 223. In yet another embodiment, the order may be a combination of one or more traditional orders (e.g., chronological order) and one or more ranking orders.

For example and in one embodiment, once the avatar is ready to be published in the avatar store, auction/bidding logic 223 may notify the advertiser the location in the order where their avatar is to be listed and displayed in the avatar store. Additionally, the advertiser may be offered an opportunity to bid on obtaining or maintaining a higher rank in the order to actively push the brand avatars to the end-users. For example, if the Coke® bottle is to be listed at number 3 in the order and the first two are Coke®'s direct competitors, Coke® may choose to remain at number 3 and disregard the notice. However, for example, if the number 1 avatar on the list is the Pepsi® read-white-blue circle avatar, Coke®, sensing direct competition with Pepsi®, may choose to bid on obtaining the number 1 position on the list. Similarly, even if the Pepsi® avatar is below the Coke® avatar, such as at number 5, Coke® may still wish to participate in the bidding process to remain at number 3 and/or ahead of Pepsi® on the list.

In one embodiment, the advertiser, such as Coke®, may be allowed to participate in an auction-like bidding process, facilitated by auction/bidding logic 223, through pricing/bidding logic 281 at advertiser-based mechanism 271. It is contemplated that the auction offered via auction/bidding logic 223 may not be limited to any particular form or style auction and may offer any combination of various auction techniques. For example, the advertiser may be given an option of paying a flat fee of $50,000 to the provider to stay at number 1 on the list for 3 calendar months or bid for the highest ranking starting, for example, at $10,000 with a time limit of, for example, 48 hours. The advertiser may participate in the bidding process at computing device 270 via pricing/bidding logic 281. Once the bidding process, any or all avatar sponsors or advertisers may be allowed to participate for the ranking; for example, the auction may not be limited only to Coke® and Pepsi® and that any of the other registered advertisers (e.g., Disney®, Geico®, BMW®, One Direction™, Columbia Records®, The Hunger Games™, Padez Health Agency™, Los Angeles Dodgers®, etc.) may also be allowed to participate in the auction. For example, in the absence of a payment of, for example, the aforementioned flat fee, upon completion of the allocated time (e.g., 48 hours), the bidding process may end and the highest bidder (e.g., Coke® winning the auction with a final bid of $0.30/avatar for 1 million avatars or $27,000 for 3 months or a combination thereof, etc.) may be allowed to have the number 1 position for their avatar (e.g., Coke® bottle) via ranking/sorting logic 275.

In one embodiment, the top position may be offered for a fixed period of time, such as 1 month, during which the winner may be allowed to maintain their avatar at the number 1 location on the list of avatars published by the avatar store. In another embodiment, all or certain list positions (e.g., top three positions) may be fluid and subject to ongoing bidding processes where the advertisers may be allowed to continuously bid to maintain their positions or obtain new positions on the store avatar list.

Referring back to the user-side, once the user has obtained and downloaded the selected avatar via content reception/downloading module 247 at computing device 240, the user may choose to do any number of things with the avatar. Naturally, the user may choose to do nothing, but in some embodiments, the user may use the avatar as wallpaper for the computer display screen, brand-morph the avatar with other content, forward the brand avatar or brand-morphed avatar to others, such as a family and friends, etc. In one embodiment, the user may choose to perform brand-morphism of the downloaded brand avatar, via customization/morphing logic 249, to generate and brand-morphed avatar. For example, the user may morph a brand avatar with user-provided content (e.g., voice, video, text, features, animation, etc.) such that a customized brand-morphed message is generated, merging the brand avatar of the advertiser with the user's content.

It is contemplated that the novel brand-morphism technique facilitated by customization/morphing logic 249 is not limited to any particular type or form of avatar or any particular type or form of user content. For example, continuing with the Coke® bottle, the user may morph the avatar to include the user's facial feature with a voice message saying, for example, “Happy Birthday!” such that the avatar would appear as an animated and talking Coke® bottle having embedded user's facial features (e.g., eyes, lips, nose, etc.) where the user's mouth on the Coke® bottle speaks “Happy Birthday!”. Similarly, the Coke® polar bear may be morphed into a holding a flag having written on it the user's text message reciting “Happy New Year!”. As aforementioned, embodiments are not limited to any particular form or pattern or usage for this technique and any number and type of brand avatars may be morphed with any number and type of user-provided message such that user-generated and user-customized brand-morphed avatars can be created.

Furthermore, in one embodiment, various audio/visual devices 257 and/or sensors 259 may be used to capture user characteristics to help brand-morph various brand avatars and user contents. For example, audio/visual devices 257 (e.g., camera, microphone, etc.) may be used to capture the user's visual (e.g., video, photo, etc.) and audio characteristics, such as video or photos of the user's face, facial features, body, measurements (e.g., distance between the user's eyes), voice, speech patterns, etc. Similarly, for example, sensors 259 may include biometric sensors to sense the user's physical attributes (e.g., fingerprints, facial features/measurements, speech patterns, retinal patterns, etc.) and/or behavioral characteristics (e.g., body movement, visual focus patterns, eye movement, speed and strength of key inputs, etc.). Sensors 259 include context-aware sensors and work with and/or facilitate audio/visual devices 257 to detect and monitor some of the user's characteristics, such as using a camera to detect a user's facial features, such as distance between the user's eyes, etc., microphone to detect the user's voice patterns, etc. Further, for example and in some embodiments, such sensors 259 may be used to authenticate the user to use computing device 240 and in some embodiments, such data collected by sensors 259 may be provided to and used by authentication logic 203 to authenticate the user and/or computing device 240 and/or other users accessing access customization mechanism 110.

As aforementioned, upon brand-morphing the avatar, the user may choose to send the morphed avatar to family, friends, colleagues, neighbors, etc. Using the examples above, the user may send/forward (e.g., via email using one or more of Outlook®, Hotmail®, Gmail®, Yahoo®, etc., text messaging using a local short message service (SMS) application or one or more of downloaded applications, such as WhatsApp®, Viber®, Skype®, Tango®, etc.) the Coke® bottle morphed avatar to his wife to wish her a happy birthday. Similarly, the user may choose to share (e.g., via one or more of social or business networking websites, such as Facebook®, Twitter®, LinkedIn®, etc.) the Coke® polar bear avatar with any number of his friends, family, colleagues, and even strangers, etc., to wish them all a happy new year. It is contemplated that embodiments are not limited to any particular transmission/sharing method or medium and that users may choose to any number and type of techniques to send/forward or share their avatars. For example, users may choose to send or forward their avatars via email, texting, etc., or simply share them via one or more social and/or business networking websites. Further, for example, one user may choose to send/forward her brand-morphed (video) avatar as a full avatar in an email to her corresponding recipient that the recipient can watch as soon it is received, while another user may choose to save the bandwidth and email simply a link (e.g., Uniform Resource Locator (URL) link, etc.) to his brand-morphed (video) avatar to his corresponding receipt which the recipient may click to watch the avatar. For example, the URL link may be part of a message, such as: “You have a Pocket Avatar message waiting for you. Please click: http://www.pocketavatars/com/api/download/video”, etc.

Regardless of whether the user chooses to forward or share an avatar, depending on the billing method agreed upon and selected by selection/payment logic 279, the advertiser may be charged or billed for each avatar that is sent or shared by the user. For example, since sharing of an avatar (either morphed or un-morphed) with a hundred users via their computing devices is essentially the same as advertising the advertiser's brand to those hundred recipients (event thought they did not explicitly downloaded the brand avatar), the provider may bill the advertiser for each avatar that is forwarded or shared. For example, as previously discussed, selection/payment logic 277 may facilitate pricing logic 279 to enforce a pricing arrangement which includes, for example, $0.10/downloaded/forwarded-shared avatar or $0.15/downloaded avatar and $0.10/forwarded-shared avatar, or the like.

In order to properly enforce such price arrangements as well as to share advertisement-hit numbers with advertisers so they may properly evaluate their advertisement campaigns, distribution/tracking logic 251 at user-based mechanism 241 may track each downloading, forwarding, and sharing of each avatar relating to each advertiser using computing device 240 and/or via a registration account relating to the user associated with computing device 240 if the user uses multiple computing devices. For example, with regard to the Coke® bottle avatar, with each downloading, forwarding, and/or sharing of the avatar by the user, distribution and tracking logic 251 may be triggered to facilitate tracking of the event and then provide that tracking information to recording/auditing logic 225 over network 235. It is contemplated that one of the recipients of the avatar may, for example upon viewing the avatar, choose to download user-based mechanism 241 their computing device and start downloading, forwarding, and/or sharing the avatar with other users at their computing device which may lead to those events being tracked by distribution and tracking logic 251 at the recipient's computing device and the tracking information being shared with recording/auditing logic 225 over one or more networks, such as network 235.

With regard to conventional banner and popup advertisement techniques, it is not known whether the end-user actually viewed the advertisement and consequently, the advertisers do not know whether their brands are in fact reaching their customers or potential customers. Embodiments provide for tracking, via distribution and tracking logic 251, and recording, via recording/auditing logic 225, each instance (e.g., downloading, sending/forwarding, sharing, etc.) relating to an avatar, via and then providing that data, over network 235, to the corresponding advertiser so they may properly evaluate their advertisement campaign (including their financial investment, avatars, brand name and quality, products and services, etc.) and use the data to influence their immediate and/or future advertisement-related decisions. For example, upon receiving the advertisement data, an advertiser may choose to participate in an auction or bidding process to achieve a higher rating/position for one or more of their avatars on the avatar store list, etc. In one embodiment, recording/auditing logic 225 may be used to audit the data collected from or provided by distribution/tracking logic 251, such as by making sure the download was completed, the email sent was received by the recipient, etc. Further, recording/auditing logic 225 may be used for auditing accounting matters, such as to track and correct any billing discrepancies with users and/or advertisers, etc.

Communication logic 255 and communication logic 283 of computing device 240 and computing device 270, respectively, may be similar to or the same as communication/compatibility logic 227 and may be used to facilitate communication with customization mechanism 110 and its host machine, such as computing device 100 of FIG. 1, and any number and type of components and devices, such as database 290, other advertisement distribution servers, other service provider servers, and/or other client computing devices. Further, logic 227, 255, 283 may be arranged or configured to use any one or more of communication technologies, such as wireless or wired communications and relevant protocols (e.g., Wi-Fi®, WiMAX, Ethernet, etc.), to facilitate communication over one or more networks, such as network 235 (e.g., the Internet, cloud network, proximity network, etc.) Data storage 261 and database 230, 290 may include any number and type of devices or mediums (such as data storage devices, hard drives, solid-state drives, hard disks, memory cards or devices, memory circuits, etc.) for short-time and/or long-term storage of data (e.g., brand avatars, brand-morphed avatars, advertisement content, tracking and/or recorded distribution data, etc.), policies, resources, software programs or instructions, etc.

Communication/compatibility logic 227 may be used to facilitate dynamic communication and compatibility between various computing devices, such as host machine 100 of FIG. 1, computing device 240 (e.g., client computing device, such as a mobile computing device, a desktop computer, etc.), and computing device 270 (e.g., server computing device, such as a third-party/advertiser-based server computing device, etc.), storage devices, databases and/or data sources, such as database 230, networks, such as network 235 (e.g., cloud network, the Internet, intranet, cellular network, proximity networks, such as Bluetooth, Bluetooth low energy (BLE), Bluetooth Smart, Wi-Fi proximity, Radio Frequency Identification (RFID), Near Field Communication (NFC), Body Area Network (BAN), etc.), connectivity and location management techniques (e.g., Common Connectivity Framework (CCF) by Intel®, etc.), software applications/websites, (e.g., social and/or business networking websites, such as Facebook®, LinkedIn®, Google+®, Twitter®, etc., business applications, games and other entertainment applications, etc.), programming languages, etc., while ensuring compatibility with changing technologies, parameters, protocols, standards, etc.

Although one or more examples may be discussed throughout this document for brevity, clarity, and ease of understanding, it is contemplated that embodiments are not limited to any particular number and type of resources or forms of access to resources or devices or users, or the like. For example, embodiments are not limited to any particular network security infrastructures or protocols (e.g., single-sign-on (SSO) infrastructures and protocols) and may be compatible with any number and type of network security infrastructures and protocols, such as security assertion markup language (SAML), OAuth, Kerberos, etc., to be extended and used with the novel user-based avatar brand-morphism and sharing capabilities.

It is contemplated that any number and type of components may be added to and/or removed from any one or more of advertisement customization mechanism 110, user-based mechanism 241, and advertiser-based mechanism 274 to facilitate various embodiments including adding, removing, and/or enhancing certain features. For brevity, clarity, and ease of understanding of advertisement customization mechanism 110, user-based mechanism 241, and advertiser-based mechanism 274, many of the standard and/or known components, such as those of a computing device, are not shown or discussed here. It is contemplated that embodiments, as described herein, are not limited to any particular technology, topology, system, architecture, and/or standard and are dynamic enough to adopt and adapt to any future changes.

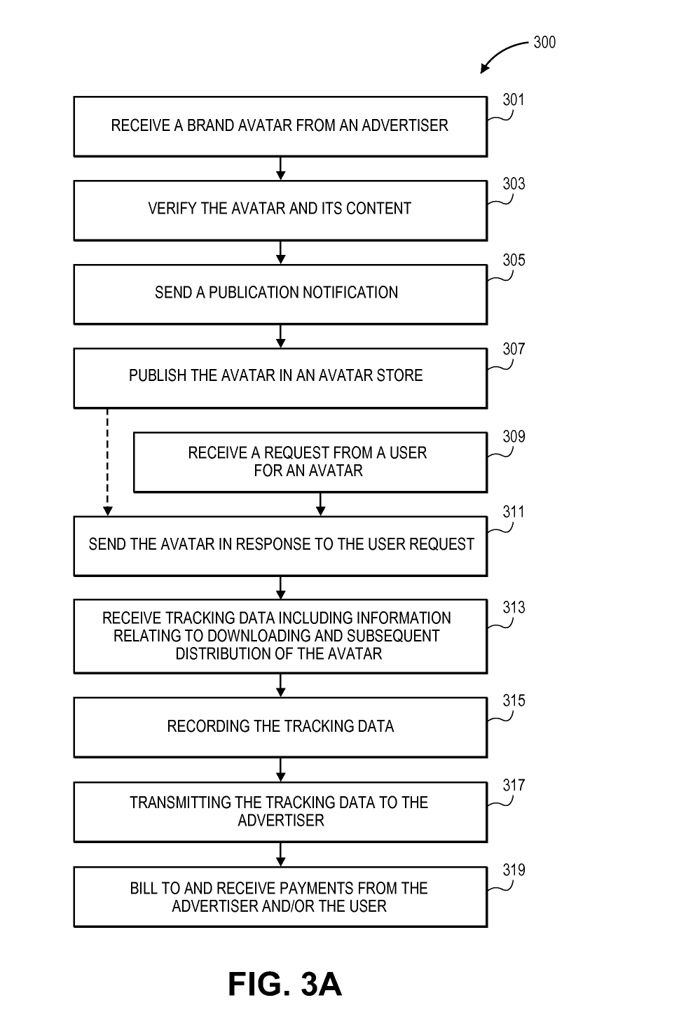

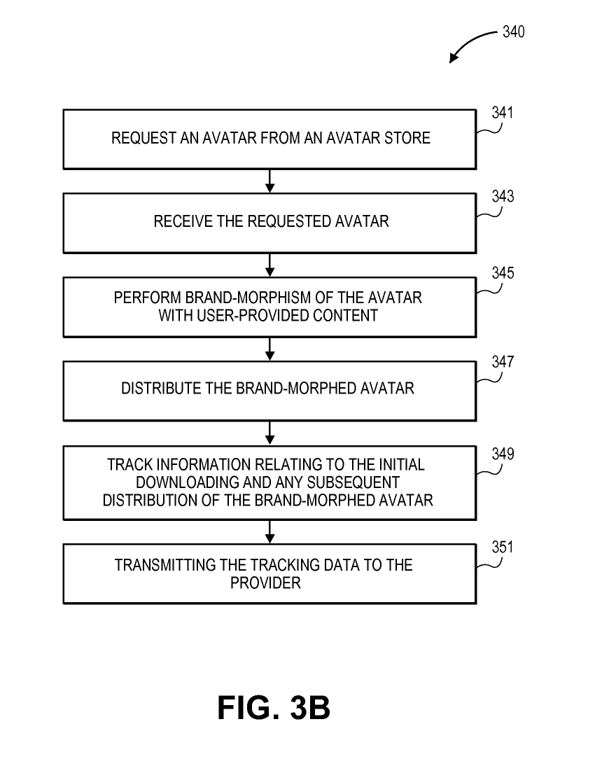

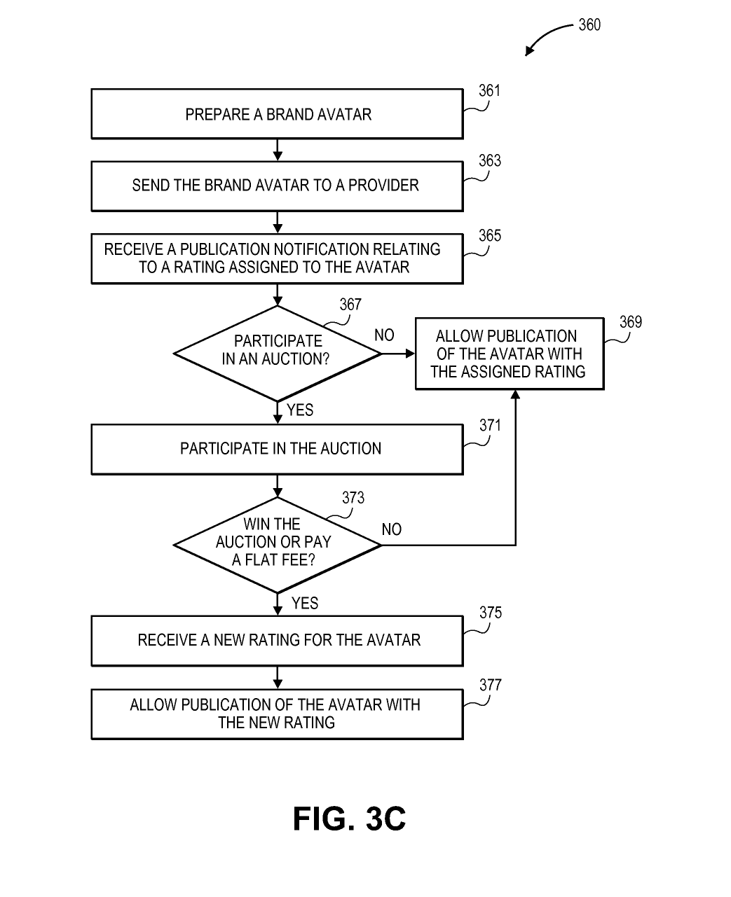

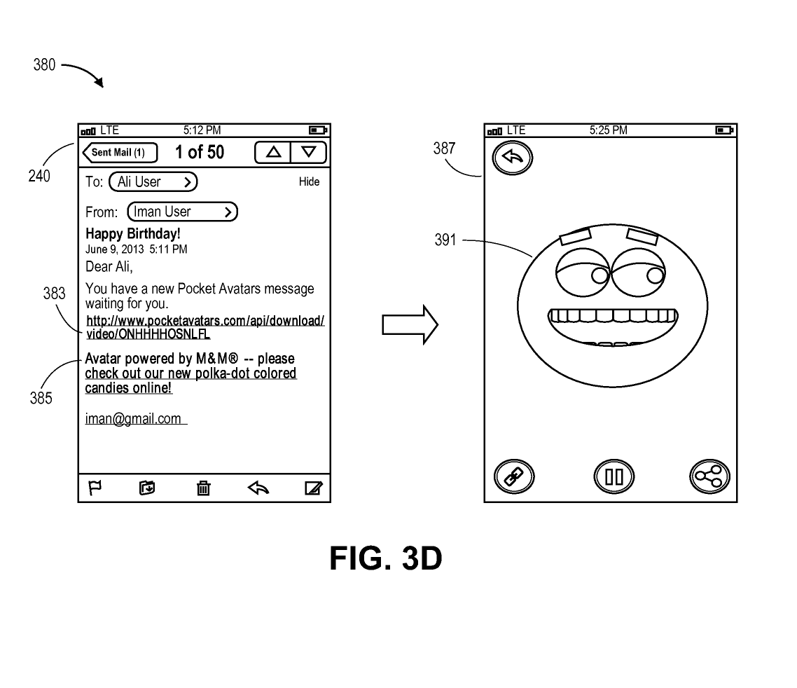

FIG. 3A illustrates a method 300 for facilitating publication of brand avatars for user-based customization and brand-morphism according to one embodiment. Method 300 may be performed by processing logic that may comprise hardware (e.g., circuitry, dedicated logic, programmable logic, etc.), software (such as instructions run on a processing device), or a combination thereof. In one embodiment, method 300 may be performed by one or more of customization mechanism 110, user-based mechanism 241, and advertiser-based mechanism 271 of FIG. 2. The processes of method 300 are illustrated in linear sequences for brevity and clarity in presentation. However, it is contemplated that any number of them can be performed in parallel, asynchronously, or in different orders.

Method 300 begins at block 301 with receiving a brand avatar (e.g., symbol, logo, mascot, etc.) from an advertiser for publication at an avatar store for sale and distribution for advertisement purposes. At block 303, the brand avatar and its content are verified prior to publication. At block 305, upon verification, a publication notification is sent to the advertiser. The publication notification may provide information relating to the assigned ranking of the avatar and/or where the avatar might be place within the list of avatars. As will be further described with reference to FIG. 3C, in response to the publication notification, the advertiser may choose to participate in an auction, if offered by the provider, to participate in a bidding process to increase or maintain the assigned ranking in order to achieve a higher position or maintain the same position on the avatar list published by the provider. The brand avatar list may be published via a brand avatar store which may be published as a website having assigned a URL link (e.g., http://www.pocketavatars.com) that any end-user may access via one or more client computing devices, such as a desktop, a smartphone, a tablet computer, etc. At block 307, the advertiser's brand avatar is published, at the assigned or increased ranking, on the brand avatar list and provided in the brand avatar store to be accessed by users.

At block 309, a request for the brand avatar is received from a user accessing the avatar store via a computing device. At block 311, in response to the user request, the requested brand avatar is sent to the user via the computing device, where sending refers to allowing the user to download the avatar from the avatar store. At block 313, tracking data is received from the user's computing device, over a network (e.g., Internet), where tracking data may include information relating to the initial downloading of the avatar and any subsequent distribution (e.g., emailing, texting, sharing on a networking website, etc.) of the avatar (e.g., brand-morphed avatar) to other users. As will be further described with reference to FIG. 3B, the user may perform brand-morphing of the brand avatar with own content before distributing it to other users. At block 315, the received tracking data is recorded at the provider and further, at block 317, the tracking data is sent to the advertiser. At block 319, bills may be sent to and payment received from the advertiser and/or the user.

FIG. 3B illustrates a method 340 for facilitating brand-morphism of brand avatars and distribution of brand-morphed avatars according to one embodiment. Method 340 may be performed by processing logic that may comprise hardware (e.g., circuitry, dedicated logic, programmable logic, etc.), software (such as instructions run on a processing device), or a combination thereof. In one embodiment, method 340 may be performed by one or more of customization mechanism 110, user-based mechanism 241, and advertiser-based mechanism 271 of FIG. 2. The processes of method 340 are illustrated in linear sequences for brevity and clarity in presentation. However, it is contemplated that any number of them can be performed in parallel, asynchronously, or in different orders.

Method 340 begins at block 341 with a user requesting, via a client computing device, a brand avatar relating to an advertiser from a brand avatar store. At block 343, the user receives or downloads, at the client computing device, the requested brand avatar from the brand avatar store. At block 345, the user may perform, at the client computing device, brand-morphing of the user's own content with the downloaded brand avatar to produce a brand-morphed avatar. At block 347, the user may distribute the brand-morphed avatar form the client computing device to other users at their corresponding computing device. The distribution of the brand-morphed avatar may include texting and/or emailing of the avatar using one or more texting/emailing applications and/or sharing of the avatar at one or more social and/or business networking websites, etc. At block 349, information relating to the initial downloading of the brand avatar and any subsequent distribution of the brand-morphed avatar is tracked and collected. This information may include time and date of downloading and/or distribution, number of times the avatar is downloaded and distributed, IP addresses of the computing device where the brand-morphed avatar is distributed, etc. At block 351, the tracked information is transmitted, over a network, to the provider via a server computing device hosting advertising customization mechanism 110 of FIG. 2.

FIG. 3C illustrates a method 360 for facilitating generation and communication of brand avatars for publication according to one embodiment. Method 360 may be performed by processing logic that may comprise hardware (e.g., circuitry, dedicated logic, programmable logic, etc.), software (such as instructions run on a processing device), or a combination thereof. In one embodiment, method 360 may be performed by one or more of customization mechanism 110, user-based mechanism 241, and advertiser-based mechanism 271 of FIG. 2. The processes of method 360 are illustrated in linear sequences for brevity and clarity in presentation. However, it is contemplated that any number of them can be performed in parallel, asynchronously, or in different orders.

Method 360 begins at block 361 with preparing a brand avatar associated with an advertiser for promoting the advertiser's products and/or services, where the brand avatar may be prepared or generated at a server computing device associated with the advertiser. At block 363, once prepared, the brand avatar is sent to a service provider, over a network, via a server computing device, associated with the provider, hosting advertising customization mechanism 110 of FIG. 2. At block 365, a publication notification is received from the provider, where the publication notification may include information relating to acceptance of the brand avatar for publication and a ranking assigned to the brand avatar. The ranking may indicate the brand avatar's position/location on the avatar list published by the provider via a brand avatar store. At block 367, a decision is made as to whether the advertiser wishes to participate in an action to increase or maintain the assigned ranking. If not, at block 369, the advertiser accepts the assigned ranking and allows or permits the provider to publish the brand avatar at the assigned ranking.

Referring to block 367, if the assigned ranking is not acceptable to the advertise or it may be acceptable but it is to be maintained by the advertiser so that it is not taken over by another brand avatar by another advertiser, the advertiser may choose to participate in an auction at block 371. At the auction, the advertiser may pay a flat fee or bid to either increase the assigned ranking to a newer/higher ranking or maintain the assigned ranking so that it is not lowered by other potentially rising brand avatars. At block 373, a decision is made as to whether the advertiser pays the flat fee or wins the auction. If not, the process continues at block 369 with the advertiser allowing the publisher to publish the brand avatar at the assigned ranking. It is contemplated in some embodiments, the advertiser may choose not to proceed with the publication and pull out of the advertisement campaign.

In one embodiment, at block 375, if the advertiser pays the flat fee or wins the auction, the advertiser may receive a new publication notification with a new/higher ranking assigned to the brand avatar. At block 377, upon receiving the new/higher ranking, the advertiser may allow the publisher to proceed with publishing the brand avatar with the new/higher ranking on the avatar list.

FIG. 3D illustrates distribution 380 of a brand-morphed avatar 391 according to one embodiment. In the illustrated embodiment, a user may download a brand avatar (e.g., M&M® candy avatar), at computing device 240 (such as a smartphone, etc.), from an avatar store and choose to brand-morphed with his own content into a brand-morphed avatar 391. As illustrated, the user may choose to use an email application at computing device 381 to prepare an email having URL link 383 representing or leading to brand-morphed avatar 391, where the email may further include entity-personalized advertisement piece 385 from the advertiser (e.g., M&M®) owning the brand avatar that is being distributed as brand-morphed avatar 391. The email may then be sent from computing device 240 to another computing device 387 (like computing device 240, such as another smartphone or a tablet computer, etc.) associated with another user. Upon receiving the email at computing device 387, the other user may open the email, click on the link 383 to view (and hear) brand-morphed avatar 391 at computing device 387.

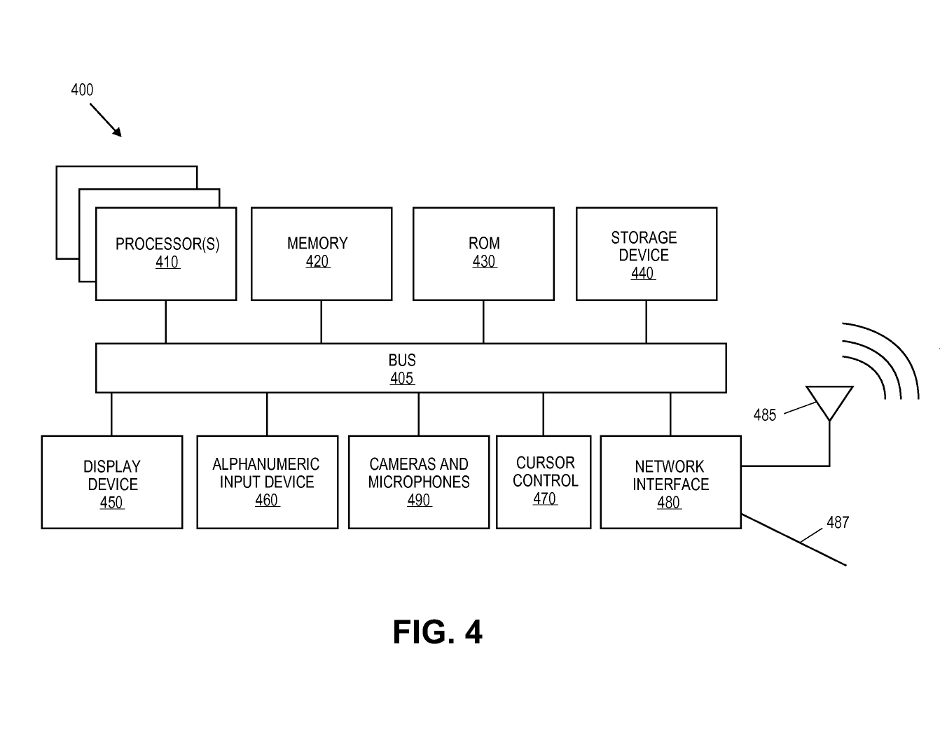

FIG. 4 illustrates an embodiment of a computing system 400. Computing system 400 represents a range of computing and electronic devices (wired or wireless) including, for example, desktop computing systems, laptop computing systems, cellular telephones, personal digital assistants (PDAs) including cellular-enabled PDAs, set top boxes, smartphones, tablets, etc. Alternate computing systems may include more, fewer and/or different components. Computing device 400 may be the same as or similar to or include host machine 100 of FIG. 1 and/or computing devices 240, 270 of FIG. 2.

Computing system 400 includes bus 405 (or a link, an interconnect, or another type of communication device or interface to communicate information) and processor 410 coupled to bus 405 that may process information. While computing system 400 is illustrated with a single processor, electronic system 400 and may include multiple processors and/or co-processors, such as one or more of central processors, graphics processors, and physics processors, etc. Computing system 400 may further include random access memory (RAM) or other dynamic storage device 420 (referred to as main memory), coupled to bus 405 and may store information and instructions that may be executed by processor 410. Main memory 420 may also be used to store temporary variables or other intermediate information during execution of instructions by processor 410.

Computing system 400 may also include read only memory (ROM) and/or other storage device 430 coupled to bus 405 that may store static information and instructions for processor 410. Date storage device 440 may be coupled to bus 405 to store information and instructions. Date storage device 440, such as magnetic disk or optical disc and corresponding drive may be coupled to computing system 400.

Computing system 400 may also be coupled via bus 405 to display device 450, such as a cathode ray tube (CRT), liquid crystal display (LCD) or Organic Light Emitting Diode (OLED) array, to display information to a user. User input device 460, including alphanumeric and other keys, may be coupled to bus 405 to communicate information and command selections to processor 410. Another type of user input device 460 is cursor control 470, such as a mouse, a trackball, a touchscreen, a touchpad, or cursor direction keys to communicate direction information and command selections to processor 410 and to control cursor movement on display 450. Camera and microphone arrays 490 of computer system 400 may be coupled to bus 405 to observe gestures, record audio and video and to receive and transmit visual and audio commands.

Computing system 400 may further include network interface(s) 480 to provide access to a network, such as a local area network (LAN), a wide area network (WAN), a metropolitan area network (MAN), a personal area network (PAN), Bluetooth, a cloud network, a mobile network (e.g., 3^{rd} Generation (3G), etc.), an intranet, the Internet, etc. Network interface(s) 480 may include, for example, a wireless network interface having antenna 485, which may represent one or more antenna(e). Network interface(s) 480 may also include, for example, a wired network interface to communicate with remote devices via network cable 487, which may be, for example, an Ethernet cable, a coaxial cable, a fiber optic cable, a serial cable, or a parallel cable.

Network interface(s) 480 may provide access to a LAN, for example, by conforming to IEEE 802.11b and/or IEEE 802.11g standards, and/or the wireless network interface may provide access to a personal area network, for example, by conforming to Bluetooth standards. Other wireless network interfaces and/or protocols, including previous and subsequent versions of the standards, may also be supported.

In addition to, or instead of, communication via the wireless LAN standards, network interface(s) 480 may provide wireless communication using, for example, Time Division, Multiple Access (TDMA) protocols, Global Systems for Mobile Communications (GSM) protocols, Code Division, Multiple Access (CDMA) protocols, and/or any other type of wireless communications protocols.

Network interface(s) 480 may include one or more communication interfaces, such as a modem, a network interface card, or other well-known interface devices, such as those used for coupling to the Ethernet, token ring, or other types of physical wired or wireless attachments for purposes of providing a communication link to support a LAN or a WAN, for example. In this manner, the computer system may also be coupled to a number of peripheral devices, clients, control surfaces, consoles, or servers via a conventional network infrastructure, including an Intranet or the Internet, for example.

It is to be appreciated that a lesser or more equipped system than the example described above may be preferred for certain implementations. Therefore, the configuration of computing system 400 may vary from implementation to implementation depending upon numerous factors, such as price constraints, performance requirements, technological improvements, or other circumstances. Examples of the electronic device or computer system 400 may include without limitation a mobile device, a personal digital assistant, a mobile computing device, a smartphone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combinations thereof.

Embodiments may be implemented as any or a combination of: one or more microchips or integrated circuits interconnected using a parentboard, hardwired logic, software stored by a memory device and executed by a microprocessor, firmware, an application specific integrated circuit (ASIC), and/or a field programmable gate array (FPGA). The term “logic” may include, by way of example, software or hardware and/or combinations of software and hardware.

Embodiments may be provided, for example, as a computer program product which may include one or more machine-readable media having stored thereon machine-executable instructions that, when executed by one or more machines such as a computer, network of computers, or other electronic devices, may result in the one or more machines carrying out operations in accordance with embodiments described herein. A machine-readable medium may include, but is not limited to, floppy diskettes, optical disks, CD-ROMs (Compact Disc-Read Only Memories), and magneto-optical disks, ROMs, RAMs, EPROMs (Erasable Programmable Read Only Memories), EEPROMs (Electrically Erasable Programmable Read Only Memories), magnetic or optical cards, flash memory, or other type of media/machine-readable medium suitable for storing machine-executable instructions.

Moreover, embodiments may be downloaded as a computer program product, wherein the program may be transferred from a remote computer (e.g., a server) to a requesting computer (e.g., a client) by way of one or more data signals embodied in and/or modulated by a carrier wave or other propagation medium via a communication link (e.g., a modem and/or network connection).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to performs acts of the method, or of an apparatus or system for facilitating content-morphism and distribution of advertisement content and user content according to embodiments and examples described herein.

Some embodiments pertain to Example 1 that includes an apparatus to facilitate publication of advertiser content, comprising: reception logic to receive an advertiser content to be published on a publication list, wherein the advertiser content is associated with an advertising entity; content verification logic to verify the advertiser content for publication, wherein the content verification logic includes ranking/sorting logic to assign a ranking to the advertiser content, wherein the ranking represents a position on the publication list; transmission logic to transmit a publication notification identifying the ranking assigned to the advertiser content; and auction/bidding logic to facilitate an auction for bidding to allow the advertising entity to obtain a higher ranking for the advertiser content than the assigned ranking, if the assigned ranking is rejected by the advertising entity.

Example 2 includes the subject matter of Example 1, wherein the bidding is further to allow the advertising entity to fix the assigned ranking associated with the advertiser content such that the assigned ranking is not lowered against rankings associated with other advertiser contents,

wherein the auction further comprises offering a flat fee-based purchase of the higher ranking or fixing of the assigned ranking associated with the advertiser content.

Example 3 includes the subject matter of Example 1 or 2, further comprising publication logic to publish the advertiser content on the publication list at the assigned ranking, if a failure notification is received with regard to the advertising entity failing to win the auction or accept the flat fee-based purchase, wherein the publication list is published via a publication store representing a website.

Example 4 includes the subject matter of Example 1 or 2, wherein the publication logic is further to publish the advertiser content on the publication list, via the publication store, at the higher ranking or fixed assigned ranking, if a success notification is received with regard to the advertising entity succeeding in winning the auction or accepting the flat fee-based purchase.

Example 5 includes the subject matter of Example 1, further comprising: authentication logic to authenticate one or more of the advertising entity, the advertiser content, and one or more computing devices associated with the advertising entity, wherein the advertiser content is received over a network; a filter of the content verification logic to filter contents associated with the advertiser content, wherein the content verification logic further includes modification logic to modify the contents associated with the advertiser content; billing logic to offer, to the advertising entity, one or more billing options relating to the advertiser content; and recording/auditing logic to receiving tracking data relating to the advertiser content, wherein the tracking data includes information relating to downloading of the advertiser content at a computing device and distribution of the advertiser content to other computing devices.

Some embodiments pertain to Example 6 that includes an apparatus to facilitate content-morphism and distribution of advertiser content, comprising: store access logic to access a publication store having a plurality of advertiser contents associated with a plurality of advertising entities, wherein the store access logic is further to request an advertiser content associated with an advertising entity; a content reception/downloading module to receive the requested advertiser content, wherein receiving includes downloading the advertiser content; customization/morphing logic to perform brand-morphing of the advertiser content with user content provided by a user to generate a morphed content; and distribution and tracking logic to distribute the morphed content to one or more computing devices corresponding to one or more users, wherein the one or more users are associated with the user.

Example 7 includes the subject matter of Example 6, wherein the user content comprises one or more messages generated by the user, via the apparatus, wherein the one or more messages include one or more of a text message, a voice message, a video message, a static image, a feature movement, and an animation message, and wherein the advertiser content comprises one or more of a movie, music, a text, a webpage, a blog, an audio recording, and an avatar including a brand avatar.

Example 8 includes the subject matter of Example 6 or 7, wherein the one or more messages are generated using one or more of audio/visual devices and sensors, wherein the audio/visual devices include one or more of a camera, a microphone, and a speaker, and wherein the sensors include one or more of a voice detection sensor, a motion detection sensor, a location detection sensor, and a biometric sensor.

Some embodiments pertain to Example 9 that includes a method for facilitating publication of advertiser content, comprising: receiving an advertiser content to be published on a publication list, wherein the advertiser content is associated with an advertising entity; verifying the advertiser content for publication, wherein verifying further includes assigning a ranking to the advertiser content, wherein the ranking represents a position on the publication list; transmitting a publication notification identifying the ranking assigned to the advertiser content; and facilitating an auction for bidding to allow the advertising entity to obtain a higher ranking for the advertiser content than the assigned ranking, if the assigned ranking is rejected by the advertising entity.

Example 10 includes the subject matter of Example 9, wherein the bidding is further to allow the advertising entity to fix the assigned ranking associated with the advertiser content such that the assigned ranking is not lowered against rankings associated with other advertiser contents, wherein the auction further comprises offering a flat fee-based purchase of the higher ranking or fixing of the assigned ranking associated with the advertiser content.

Example 11 includes the subject matter of Example 9, further comprising publishing the advertiser content on the publication list at the assigned ranking, if a failure notification is received with regard to the advertising entity failing to win the auction or accept the flat fee-based purchase, wherein the publication list is published via a publication store representing a website.

Example 12 includes the subject matter of Example 9, further comprising publishing the advertiser content on the publication list, via the publication store, at the higher ranking or fixed assigned ranking, if a success notification is received with regard to the advertising entity succeeding in winning the auction or accepting the flat fee-based purchase.

Example 13 includes the subject matter of Example 9, further comprising: authenticating one or more of the advertising entity, the advertiser content, and one or more computing devices associated with the advertising entity, wherein the advertiser content is received over a network; filtering contents associated with the advertiser content, wherein the content verification logic further includes modification logic to modify the contents associated with the advertiser content; offering, to the advertising entity, one or more billing options relating to the advertiser content; and receiving tracking data relating to the advertiser content, wherein the tracking data includes information relating to downloading of the advertiser content at a computing device and distribution of the advertiser content to other computing devices.

Some embodiments pertain to Example 14 that includes a method for facilitating content-morphism and distribution of advertiser contents, comprising: accessing an avatar store having a plurality of advertiser contents associated with a plurality of advertising entities, wherein accessing further includes requesting an advertiser content associated with an advertising entity; receiving the requested advertiser content, wherein receiving includes downloading the advertiser content; performing brand-morphing of the advertiser content with content provided by a user to generate a brand-morphed avatar; and distributing the brand-morphed avatar to one or more computing devices corresponding to one or more users, wherein the one or more users are associated with the user.

Example 15 includes the subject matter of Example 14, wherein the content comprises one or more messages generated by the user, via the apparatus, wherein the one or more messages include one or more of a text message, a voice message, a video message, and an animation message.

Example 16 includes the subject matter of Example 15, wherein the one or more messages are generated using one or more of audio/visual devices and sensors, wherein the audio/visual devices include one or more of a camera, a microphone, and a speaker, and wherein the sensors include one or more of a voice detection sensor, a motion detection sensor, a location detection sensor, and a biometric sensor.

Some embodiments pertain to Example 17 that includes at least one machine-readable medium comprising a plurality of instructions that in response to being executed on a computing device, causes the computing device to carry out operations according to any one of the aforementioned examples 9 to 13.

Some embodiments pertain to Example 18 that includes at least one machine-readable medium comprising a plurality of instructions that in response to being executed on a computing device, causes the computing device to carry out operations according to any one of the aforementioned examples 14 to 16.

Some embodiments pertain to Example 19 that includes at least one non-transitory or tangible machine-readable medium comprising a plurality of instructions that in response to being executed on a computing device, causes the computing device to carry out operations according to any one of the aforementioned examples 9 to 13.

Some embodiments pertain to Example 20 that includes at least one non-transitory or tangible machine-readable medium comprising a plurality of instructions that in response to being executed on a computing device, causes the computing device to carry out operations according to any one of the aforementioned examples 14 to 16.

Some embodiments pertain to Example 21 that includes a system comprising a mechanism to carry out operations according to any one of the aforementioned examples 9 to 13.

Some embodiments pertain to Example 22 that includes a system comprising a mechanism to carry out operations according to any one of the aforementioned examples 14 to 16.

Some embodiments pertain to Example 23 that includes an apparatus comprising means to carry out operations according to any one of the aforementioned examples 9 to 13.

Some embodiments pertain to Example 24 that includes an apparatus comprising means to carry out operations according to any one of the aforementioned examples 14 to 16.

Some embodiments pertain to Example 25 that includes a computing device arranged to carry out operations according to any one of the aforementioned examples 9 to 13.

Some embodiments pertain to Example 26 that includes a computing device arranged to carry out operations according to any one of the aforementioned examples 14 to 16.

Some embodiments pertain to Example 27 that includes a communications device arranged to carry out operations according to any one of the aforementioned examples 9 to 13.

Some embodiments pertain to Example 28 that includes a communications device arranged to carry out operations according to any one of the aforementioned examples 14 to 16.

Some embodiments pertain to Example 29 that includes a system comprising a storage device having instructions, and a processor to execute the instructions to facilitate one or more operations comprising: receiving an advertiser content to be published on a publication list, wherein the advertiser content is associated with an advertising entity; verifying the advertiser content for publication, wherein verifying further includes assigning a ranking to the advertiser content, wherein the ranking represents a position on the publication list; transmitting a publication notification identifying the ranking assigned to the advertiser content; and facilitating an auction for bidding to allow the advertising entity to obtain a higher ranking for the advertiser content than the assigned ranking, if the assigned ranking is rejected by the advertising entity.

Example 30 includes the subject matter of Example 29, wherein the bidding is further to allow the advertising entity to fix the assigned ranking associated with the advertiser content such that the assigned ranking is not lowered against rankings associated with other advertiser contents, wherein the auction further comprises offering a flat fee-based purchase of the higher ranking or fixing of the assigned ranking associated with the advertiser content.

Example 31 includes the subject matter of Example 29, wherein the one or more operations further comprise publishing the advertiser content on the publication list at the assigned ranking, if a failure notification is received with regard to the advertising entity failing to win the auction or accept the flat fee-based purchase, wherein the publication list is published via a publication store representing a website.

Example 32 includes the subject matter of Example 29, wherein the one or more operations further comprise publishing the advertiser content on the publication list, via the publication store, at the higher ranking or fixed assigned ranking, if a success notification is received with regard to the advertising entity succeeding in winning the auction or accepting the flat fee-based purchase.

Example 33 includes the subject matter of Example 29, wherein the one or more operations further comprise: authenticating one or more of the advertising entity, the advertiser content, and one or more computing devices associated with the advertising entity, wherein the advertiser content is received over a network; filtering contents associated with the advertiser content, wherein the content verification logic further includes modification logic to modify the contents associated with the advertiser content; offering, to the advertising entity, one or more billing options relating to the advertiser content; and receiving tracking data relating to the advertiser content, wherein the tracking data includes information relating to downloading of the advertiser content at a computing device and distribution of the advertiser content to other computing devices.

Some embodiments pertain to Example 34 that includes a system comprising a storage device having instructions, and a processor to execute the instructions to facilitate one or more operations comprising: accessing an avatar store having a plurality of advertiser contents associated with a plurality of advertising entities, wherein accessing further includes requesting an advertiser content associated with an advertising entity; receiving the requested advertiser content, wherein receiving includes downloading the advertiser content; performing brand-morphing of the advertiser content with content provided by a user to generate a brand-morphed avatar; and distributing the brand-morphed avatar to one or more computing devices corresponding to one or more users, wherein the one or more users are associated with the user.

Example 35 includes the subject matter of Example 34, wherein the content comprises one or more messages generated by the user, via the apparatus, wherein the one or more messages include one or more of a text message, a voice message, a video message, and an animation message.

Example 36 includes the subject matter of Example 34, wherein the one or more messages are generated using one or more of audio/visual devices and sensors, wherein the audio/visual devices include one or more of a camera, a microphone, and a speaker, and wherein the sensors include one or more of a voice detection sensor, a motion detection sensor, a location detection sensor, and a biometric sensor.

Some embodiments pertain to Example 37 that includes an apparatus comprising: means for receiving an advertiser content to be published on a publication list, wherein the advertiser content is associated with an advertising entity; means for verifying the advertiser content for publication, wherein verifying further includes assigning a ranking to the advertiser content, wherein the ranking represents a position on the publication list; means for transmitting a publication notification identifying the ranking assigned to the advertiser content; and means for facilitating an auction for bidding to allow the advertising entity to obtain a higher ranking for the advertiser content than the assigned ranking, if the assigned ranking is rejected by the advertising entity.

Example 38 includes the subject matter of Example 37, wherein the bidding is further to allow the advertising entity to fix the assigned ranking associated with the advertiser content such that the assigned ranking is not lowered against rankings associated with other advertiser contents, wherein the auction further comprises offering a flat fee-based purchase of the higher ranking or fixing of the assigned ranking associated with the advertiser content.

Example 39 includes the subject matter of Example 37, further comprising means for publishing the advertiser content on the publication list at the assigned ranking, if a failure notification is received with regard to the advertising entity failing to win the auction or accept the flat fee-based purchase, wherein the publication list is published via a publication store representing a website.

Example 40 includes the subject matter of Example 37, further comprising means for publishing the advertiser content on the publication list, via the publication store, at the higher ranking or fixed assigned ranking, if a success notification is received with regard to the advertising entity succeeding in winning the auction or accepting the flat fee-based purchase.

Example 41 includes the subject matter of Example 37, further comprising: means for authenticating one or more of the advertising entity, the advertiser content, and one or more computing devices associated with the advertising entity, wherein the advertiser content is received over a network; means for filtering contents associated with the advertiser content, wherein the content verification logic further includes modification logic to modify the contents associated with the advertiser content; means for offering, to the advertising entity, one or more billing options relating to the advertiser content; and means for receiving tracking data relating to the advertiser content, wherein the tracking data includes information relating to downloading of the advertiser content at a computing device and distribution of the advertiser content to other computing devices.

Some embodiments pertain to Example 42 that includes an apparatus comprising: accessing an avatar store having a plurality of advertiser contents associated with a plurality of advertising entities, wherein accessing further includes requesting an advertiser content associated with an advertising entity; receiving the requested advertiser content, wherein receiving includes downloading the advertiser content; performing brand-morphing of the advertiser content with content provided by a user to generate a brand-morphed avatar; and distributing the brand-morphed avatar to one or more computing devices corresponding to one or more users, wherein the one or more users are associated with the user.

Example 43 includes the subject matter of Example 42, wherein the content comprises one or more messages generated by the user, via the apparatus, wherein the one or more messages include one or more of a text message, a voice message, a video message, and an animation message.

Example 44 includes the subject matter of Example 42, wherein the one or more messages are generated using one or more of audio/visual devices and sensors, wherein the audio/visual devices include one or more of a camera, a microphone, and a speaker, and wherein the sensors include one or more of a voice detection sensor, a motion detection sensor, a location detection sensor, and a biometric sensor.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

1-25. (canceled)

26. An apparatus comprising:
reception logic to receive an advertiser content to be published on a publication list, wherein the advertiser content is associated with an advertising entity;
content verification logic to verify the advertiser content for publication, wherein the content verification logic includes ranking/sorting logic to assign a ranking to the advertiser content, wherein the ranking represents a position on the publication list;
transmission logic to transmit a publication notification identifying the ranking assigned to the advertiser content; and
auction/bidding logic to facilitate an auction for bidding to allow the advertising entity to obtain a higher ranking for the advertiser content than the assigned ranking, if the assigned ranking is rejected by the advertising entity.

27. The apparatus of claim 26, wherein the bidding is further to allow the advertising entity to fix the assigned ranking associated with the advertiser content such that the assigned ranking is not lowered against rankings associated with other advertiser contents,
wherein the auction further comprises offering a flat fee-based purchase of the higher ranking or fixing of the assigned ranking associated with the advertiser content.

28. The apparatus of claim 26, further comprising publication logic to publish the advertiser content on the publication list at the assigned ranking, if a failure notification is received with regard to the advertising entity failing to win the auction or accept the flat fee-based purchase, wherein the publication list is published via a publication store representing a website.

29. The apparatus of claim 26, wherein the publication logic is further to publish the advertiser content on the publication list, via the publication store, at the higher ranking or fixed assigned ranking, if a success notification is received with regard to the advertising entity succeeding in winning the auction or accepting the flat fee-based purchase.

30. The apparatus of claim 26, further comprising authentication logic to authenticate one or more of the advertising entity, the advertiser content, and one or more computing devices associated with the advertising entity, wherein the advertiser content is received over a network.

31. The apparatus of claim 30, further comprising a filter of the content verification logic to filter contents associated with the advertiser content, wherein the content verification logic further includes modification logic to modify the contents associated with the advertiser content.

32. The apparatus of claim 30, further comprising:
billing logic to offer, to the advertising entity, one or more billing options relating to the advertiser content; and
recording/auditing logic to receiving tracking data relating to the advertiser content, wherein the tracking data includes information relating to downloading of the advertiser content at a computing device and distribution of the advertiser content to other computing devices.

33. An apparatus comprising:
store access logic to access a publication store having a plurality of advertiser contents associated with a plurality of advertising entities, wherein the store access logic is further to request an advertiser content associated with an advertising entity;
a content reception/downloading module to receive the requested advertiser content, wherein receiving includes downloading the advertiser content;
customization/morphing logic to perform brand-morphing of the advertiser content with user content provided by a user to generate a morphed content; and
distribution and tracking logic to distribute the morphed content to one or more computing devices corresponding to one or more users, wherein the one or more users are associated with the user.

34. The apparatus of claim 33, wherein the user content comprises one or more messages generated by the user, via the apparatus, wherein the one or more messages include one or more of a text message, a voice message, a video message, a static image, a feature movement, and an animation message.

35. The apparatus of claim 34, wherein the one or more messages are generated using one or more of audio/visual devices and sensors, wherein the audio/visual devices include one or more of a camera, a microphone, and a speaker, and wherein the sensors include one or more of a voice detection sensor, a motion detection sensor, a location detection sensor, and a biometric sensor.

36. The apparatus of claim 34, wherein the advertiser content comprises one or more of a movie, music, a text, a webpage, a blog, an audio recording, and an avatar including a brand avatar.

37. A method comprising:
receiving an advertiser content to be published on a publication list, wherein the advertiser content is associated with an advertising entity;
verifying the advertiser content for publication, wherein verifying further includes assigning a ranking to the advertiser content, wherein the ranking represents a position on the publication list;
transmitting a publication notification identifying the ranking assigned to the advertiser content; and
facilitating an auction for bidding to allow the advertising entity to obtain a higher ranking for the advertiser content than the assigned ranking, if the assigned ranking is rejected by the advertising entity.

38. The method of claim 37, wherein the bidding is further to allow the advertising entity to fix the assigned ranking associated with the advertiser content such that the assigned ranking is not lowered against rankings associated with other advertiser contents,
wherein the auction further comprises offering a flat fee-based purchase of the higher ranking or fixing of the assigned ranking associated with the advertiser content.

39. The method of claim 37, further comprising publishing the advertiser content on the publication list at the assigned ranking, if a failure notification is received with regard to the advertising entity failing to win the auction or accept the flat fee-based purchase, wherein the publication list is published via a publication store representing a website.

40. The method of claim 37, further comprising publishing the advertiser content on the publication list, via the publication store, at the higher ranking or fixed assigned ranking, if a success notification is received with regard to the advertising entity succeeding in winning the auction or accepting the flat fee-based purchase.

41. The method of claim 37, further comprising authenticating one or more of the advertising entity, the advertiser content, and one or more computing devices associated with the advertising entity, wherein the advertiser content is received over a network.

42. The method of claim 41, further comprising filtering contents associated with the advertiser content, wherein the content verification logic further includes modification logic to modify the contents associated with the advertiser content.

43. The method of claim 41, further comprising:
offering, to the advertising entity, one or more billing options relating to the advertiser content; and
receiving tracking data relating to the advertiser content, wherein the tracking data includes information relating to downloading of the advertiser content at a computing device and distribution of the advertiser content to other computing devices.

44. At least one machine-readable medium comprising a plurality of instructions that in response to being executed on a computing device, causes the computing device to carry out one or more operations comprising:
receiving an advertiser content to be published on a publication list, wherein the advertiser content is associated with an advertising entity;
verifying the advertiser content for publication, wherein verifying further includes assigning a ranking to the advertiser content, wherein the ranking represents a position on the publication list;
transmitting a publication notification identifying the ranking assigned to the advertiser content; and
facilitating an auction for bidding to allow the advertising entity to obtain a higher ranking for the advertiser content than the assigned ranking, if the assigned ranking is rejected by the advertising entity.

45. The machine-readable medium of claim 44, wherein the bidding is further to allow the advertising entity to fix the assigned ranking associated with the advertiser content such that the assigned ranking is not lowered against rankings associated with other advertiser contents,
wherein the auction further comprises offering a flat fee-based purchase of the higher ranking or fixing of the assigned ranking associated with the advertiser content.

46. The machine-readable medium of claim 44, wherein the one or more operations comprise publishing the advertiser content on the publication list at the assigned ranking, if a failure notification is received with regard to the advertising entity failing to win the auction or accept the flat fee-based purchase, wherein the publication list is published via a publication store representing a website.

47. The machine-readable medium of claim 44, wherein the one or more operations comprise publishing the advertiser content on the publication list, via the publication store, at the higher ranking or fixed assigned ranking, if a success notification is received with regard to the advertising entity succeeding in winning the auction or accepting the flat fee-based purchase.

48. The machine-readable medium of claim 44, wherein the one or more operations comprise authenticating one or more of the advertising entity, the advertiser content, and one or more computing devices associated with the advertising entity, wherein the advertiser content is received over a network.

49. The machine-readable medium of claim 48, wherein the one or more operations comprise filtering contents associated with the advertiser content, wherein the content verification logic further includes modification logic to modify the contents associated with the advertiser content.

50. The machine-readable medium of claim 48, wherein the one or more operations comprise:
offering, to the advertising entity, one or more billing options relating to the advertiser content; and
receiving tracking data relating to the advertiser content, wherein the tracking data includes information relating to downloading of the advertiser content at a computing device and distribution of the advertiser content to other computing devices.
